(19) United States
(12) Patent Application Publication
(10) Pub. No.: US 2002/0126492 A1
(43) Pub. Date: Sep. 12, 2002

(54) Work light stand

(76) Inventor: Yueh Ching, Taipei (TW)

Correspondence Address: BACON & THOMAS, PLLC, 4th Floor, 625 Slaters Lane, Alexandria, VA, 22314-1176, US

(21) Appl. No.: 09/752,443

(22) Filed: Jan. 3, 2001

(51) Int. Cl. F21S 8/08

(52) U.S. Cl. 362/413; 362/419; 362/431; 362/250

(57) ABSTRACT

A work light stand, with light installed thereon, comprises an adjustable lever, with its length fixable by a fastening device; and supporting legs, hinged to said adjustable lever and maintaining said work light stand in the upright standing position. The fastening device is of a notched ring structure, where a body core pierces across the notch; and a working lever, hinged to one end of the body core, can be tightened in the notch to tighten or loosen the fastener which in turn fastens or releases between the first lever and the second lever.

### BACKGROUND OF THE INVENTION

1. Field of the Invention

The present invention relates to a fastening device for use in a work light stand; specifically to a fastening device for a work light stand with adjustable height using a single working lever to tighten or loosen the fastening device to adjust the height of the work light stand.

2. Description of the Prior Art

The work light is used extensively in many night work settings. For convenience, the conventional work light is equipped with a work light stand. As shown in FIG. 1, the work light stand 10 comprises a cross lever 11 for the installation of the work light 12 thereon, an adjustable lever 13 with its length to be fixed in position by a fastening device 14, and supporting legs 15 which are hinged to and support said adjustable lever 13 and maintain the work light stand to stand upright. Under the prior art, the adjustable lever is comprised of an upper lever 131 and a lower lever 132, where the diameter of one lever is slightly greater than that of the other, such that one can fit inside the other to adjust the combined length. The fastening device 14, comprised of a screw and a screwed socket, is installed at the juncture between the upper lever 131 and lower lever 132. The fastening device 14 locks the upper lever 131 and lower lever 132 in place and thereby fixes the heights of the work light stand by winding the screw and the screwed socket tightly together.

As the work light stand generally undergoes constant height adjustments during usage, the manner in which the adjustable lever 13 is adjusted contributes to the operational convenience of the work light stand. In the prior art, when the fastening device 14, comprised of a screw and a screwed socket, is being tightened or loosened, a user must expend greater rotational motion to unwind the screw and adjust the positions of the upper and lower levers. Because the winding of the screw determines the tightness between the upper and lower levers, the user needs to loosen the screwed socket in order to easily adjust the height of the upper and lower levers.

The object of the present invention is to provide a work light stand with a fastening device having a single lever to tighten or loosen the adjustable lever, and is suitable for use in a height adjustable work light stand.

### SUMMARY OF THE INVENTION

To overcome the inconvenience in using the conventional fastening device for the work light stand, the present invention provides a work light stand for installing work light thereon. It comprises an adjustable lever with its length fastened in place by a fastening device, and supporting legs, hinged on said adjustable lever for supporting the work light stand in the upright standing position, wherein said fastening device is a notched ring structure, and a screwed socket is connected between the two ends of the notch; one end of said screwed socket is hinged to a working lever which can tighten in between the two ends of the ring structure.

### BRIEF DESCRIPTION OF THE DRAWINGS

The many strengths and characteristics of the present invention may be further elaborated by the use of the following figures:

FIG. 1. A frontal view of the conventional work light stand.

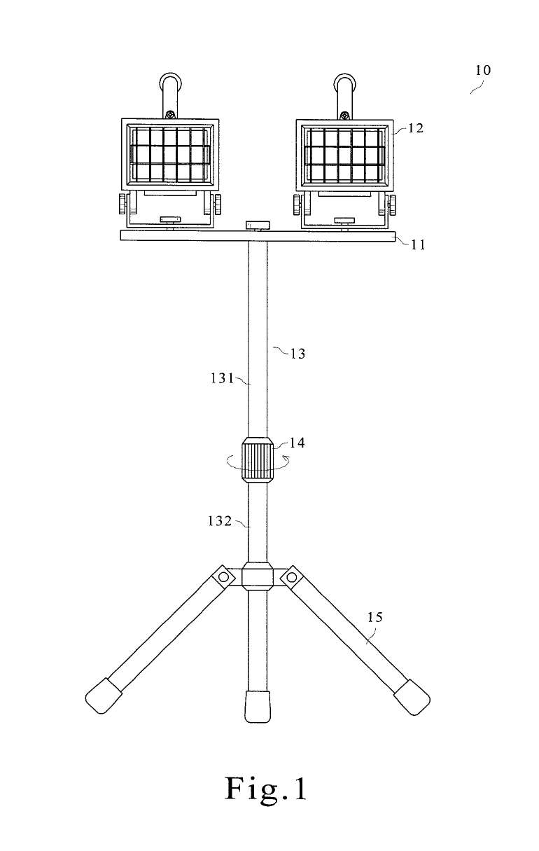

FIG. 2. A frontal view of the work light stand of the present invention.

FIG. 3. A cross-sectional view of the fastening device.

NUMBERING SCHEME

| | |
|---|---|
| 20 | Work light stand |
| 21 | Cross lever |
| 22 | Light |
| 23 | Adjustable lever |
| 231 | First lever |
| 232 | Second lever |
| 233 | Third lever |
| 24 | Fastening device |
| 241 | End |
| 242 | End |
| 243 | Screw |
| 244 | Working lever |
| 2441 | Protruding wheel |
| 245 | Screwed socket |
| 25 | Supporting legs |

### DETAILED DESCRIPTION OF THE INVENTION

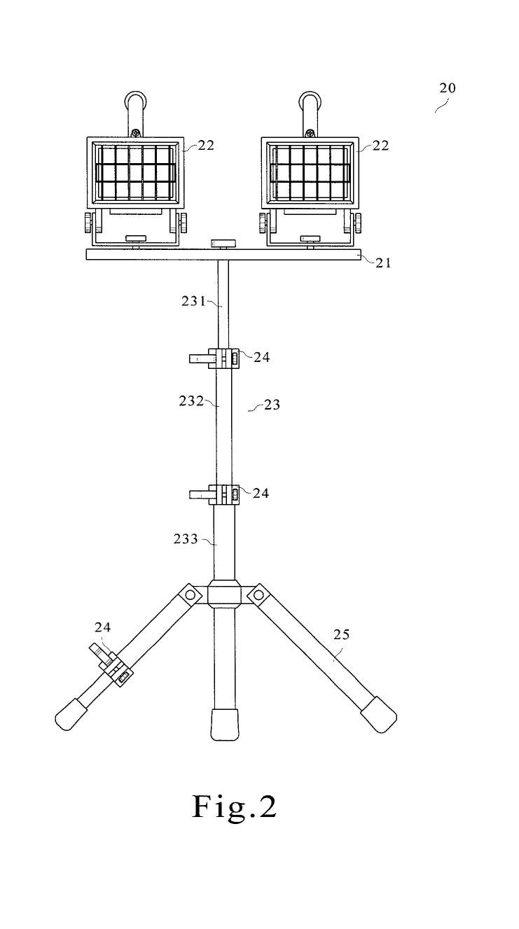

As shown in FIG. 2, the work light stand of the present invention 20 comprises a cross lever 21 for installing thereon the light 22, an adjustable lever 23 connecting to the cross lever 21 with its length fixed in place by a fastening device 24 to fix the work light stand at a desired height, and the supporting legs 25, hinged to and support the adjustable lever 23 for maintaining the work light stand in the upright standing position. The fastening device 24 comprises a working lever, which can be adjusted with single motion for tightening or loosening the fastening device, and thereby tightens or loosens the adjustable lever 23. This is distinguishable from the prior art in which multiple rotational motions are necessary for achieving gradually either the tightened or the loosened condition.

In the preferred embodiment of the present invention, the adjustable lever 23 of the work light stand 20 is comprised of a first lever 231 and a second lever 232, where the first lever 231 is connected to the cross lever 21 as shown in FIG. 2. For instance, the cross lever 21 can be fastened to one end of the first lever 231 by a screwed socket, and the second lever 232 can be hinged to a set of supporting legs 25, thus identical, as shown in FIG. 2, with how a lever 233 is hinged to the supporting legs 25 to maintain the adjustable lever 23 in the upright standing position. Then the fastening device 24 is installed at the juncture between the first lever 231 and the second lever 232 to fix the length of the adjustable lever 23 in place.

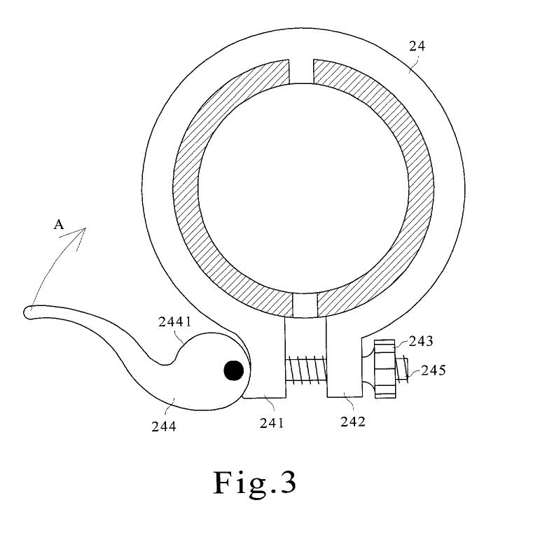

Referring to an instance of the preferred embodiment shown in FIG. 3, the fastening device 24 thereof is a notched ring structure, which can be installed at the end of the first lever 231 or the second lever 232, and such end is also a notched ring structure so that when the fastening device 24 tightens the ring structure, its inner circumference can tightly clamp on the other lever inserted therewithin to hold it at a fixed position. Furthermore, a screwed socket 245 connects the two ends 241 and 242 of the notch of the fastening device 24. As shown in FIG. 3, one end of the screwed socket 245 pierces through the end 241 of the notched ring structure and is hinged to a working lever 244; the other end of the screwed socket 245 pierces through the end 242 and is screwed on with a screw 243 pushing against the end 242. The working lever 244 is equipped with a gear mechanism 2441 so that when the working lever 244 is rotated in the direction A, the gear mechanism 2441 will force against the end 241 in the direction of end 242 so that the end of lever 231 or 232 is tightened in. Specifically, as there is no screw threading between the screwed socket 245 and each of the two ends 241 and 242 so that the end 241 can close in on the other end 242 without obstruction.

In addition, the screw 243 of the fastening device 24 can be wound up to adjust the tightness of the fastening device so that the working lever 244 can tighten or loosen the fastening device with a single operating motion.

In another instance of the preferred embodiment, because incorporating the fastening device 24 in a work light stand can achieve greater convenience, the adjustable lever 23 of the work light stand 20 can comprise a first lever 231, a second lever 232 and a third lever 233; wherein a fastening device 24 can be installed at the respective juncture between the first lever 231 and the second lever 232, and between the second lever 232 and the third lever 233 to adjust the respective length as shown in FIG. 2. Consequently, the work light stand 20 of the present invention is able to effectuate greater flexibility and convenience than that offered by the conventional stand with its adjustable lever comprising only two segments. Moreover, the supporting legs 25 of the work light stand 20 can be designed to include two adjustable segments so that the supporting legs can be adjusted to uneven terrains. For instance, the fastening device can comprise two individual ring-shaped fasteners; where the ends of the two fasteners can be fastened to the lever body proper and a single working lever at the other ends of the two fasteners can tighten or loosen the fasteners with a single motion.

What is claimed is:

1. A work light stand, with light installed thereon, that comprises an adjustable lever controlled by a fastening device; and supporting legs, hinged to said adjustable lever for maintaining said work light stand in the upright standing position; wherein said fastening device having a working lever and being installed at the juncture of said adjustable lever, such that said working lever tightens or loosens said fastening device with a single operating motion so that said fastening device can in turn fasten or release the adjustable length of said adjustable lever.

2. A work light stand as in claim 1, wherein said adjustable lever is comprised of a first lever and a second lever; and said fastener is installed at the juncture between said first lever and second lever to adjust the combined lengths of the two levers.

3. A work light stand as in claim 2, wherein said fastening device is a notched ring structure, where a body core connects across the ends of said notch such that one end of said body core is fixed in position and the other end is hinged to said working lever so that said working lever can tighten in said notch via the body core and thereby fasten said adjust lever at fixed length.

4. A work light stand as in claim 3, wherein said body core is a screwed socket, where one end of said screwed socket is fastened with a screw and fixed onto said ring structure, and said screw can adjust the degree of tightness as said working lever tightens in said notch.

5. A work light stand as in claim 1, wherein said adjustable lever is comprised of a first lever, a second lever and a third lever; such that a fastening device is respectively installed at the respective juncture between the first lever and the second lever and between the second lever and the third lever.

6. A work light stand as in claim 1, wherein said supporting legs comprise adjustable legs, and the respective lengths of said adjustable legs can be adjusted by said fastening device.

7. A work light stand as in claim 1, that further comprises a cross lever for installing light thereon, and the adjustable lever is installed and connected to said cross lever.

8. A work light stand, at least one light is installed thereon, comprising:
an adjustable lever, with length fixable by a fastening device; and
supporting legs, hinged to said adjustable lever, and maintain said work light stand in the upright standing position, with the characteristics of:
said adjustable lever comprises of a first lever and a second lever; said first lever can fit into said second lever, and said fastening device is installed at the juncture between the first lever and the second lever; said fastening device is of a notched ring structure, where a body core pierces across said notch; and a working lever hinged to one end of the body core can tighten in said notch to tighten or loosen said fastener which in turn fastens or releases therebetween the first lever and the second lever.
